(19) United States
(12) Patent Application Publication
(10) Pub. No.: US 2007/0278852 A1
(43) Pub. Date: Dec. 6, 2007

(54) IMPROVEMENT IN THE STRUCTURE OF AN AUXILIARY WHEEL BRACKET

(76) Inventor: Fuben Kan, Taipei (TW)

Correspondence Address: LEONG C LEI, PMB # 1008, 1867 YGNACIO VALLEY ROAD, WALNUT CREEK, CA, 94598, US

(21) Appl. No.: 11/421,770

(22) Filed: Jun. 2, 2006

(51) Int. Cl. B60B 27/06

(52) U.S. Cl. 301/111.06

(57) ABSTRACT

An auxiliary wheel bracket which includes a resilient body portion having an in intermediate portion, the intermediate portion being formed with recess in which is fitted a resilient member. The body portion has an upper end formed with a plurality of fixing holes, a lower end formed with a plurality of fixing holes, and a protuberance provided on an inner side of the upper end. The restoration of the body portion and the resilient member will make it easier for the rider to keep along the traveling direction even if the bicycle is slight tilted thus enhancing the rider's safety.

### BACKGROUND OF THE INVENTION

1. Field of the Invention

This invention is related to an improvement in the structure of an auxiliary wheel bracket for a bicycle, and in particular to one which can improve the controllability of a bicycle.

2. Description of the Prior Art

While of conventional structure of the auxiliary wheel bracket for a bicycle is made of metals or plastics, when tilted in the process of a straight line movement, it tends to slant towards the tilting direction. Due to the fact that having the auxiliary wheel bracket being made of rigid materials, no self adjustment is possible to make the tilting of the bicycle back to its original traveling direction. Instead, riders of the bicycle with conventional structure of the auxiliary wheel bracket have to self balance the tilting of the bicycle, which in a way reduces the efficiency and the pleasure of learning how to ride.

Moreover, because the conventional structure of the auxiliary wheel bracket is being made of hard materials, it creates larger noise in the process of the movement. The vibrating it caused when riding on uneven road is also very severe, improvement is thus necessary for the conventional structure of the auxiliary wheel bracket.

Referring to FIG. 1, the conventional auxiliary wheel bracket 10 for a bicycle is a rigid member having an upper end fastened to the axle 13 of the rear wheel 12 of the bicycle frame 11 and a lower end engaged with an auxiliary wheel 14.

Nevertheless, when tilted in the process of a straight line movement, it will tend to slant towards the tilting direction thereby producing serious vibration and noise and endangering the rider's safety.

Therefore, it is an object of the present invention to provide an improvement in the structure of auxiliary wheel bracket for a bicycle which can obviate and mitigate the above-mentioned drawbacks.

### SUMMARY OF THE INVENTION

This invention is related to an improvement in the structure of an auxiliary wheel bracket for a bicycle.

It is the primary object of the present invention to provide an improvement in the structure of an auxiliary wheel bracket which includes a resilient body portion having an intermediate position, the intermediate portion being formed with recess in which is fitted a resilient member.

It is another object of the present invention to provide an improvement in the structure of an auxiliary wheel bracket wherein the body portion has an upper end formed with a plurality of fixing holes, a lower end formed with a plurality of fixing holes, and a protuberance provided on an inner side of the upper end, whereby the restoration of the body portion and the resilient member will make it easier for the rider to keep along the traveling direction even if the bicycle is slightly tilted thus enhancing the rider's safety.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 illustrates a rear wheel mounted with an auxiliary wheel bracket according to the prior art;

FIG. 2 is a side view of an auxiliary wheel bracket according to the present invention; and

FIG. 3 is a front view of the auxiliary wheel bracket according to the present invention.

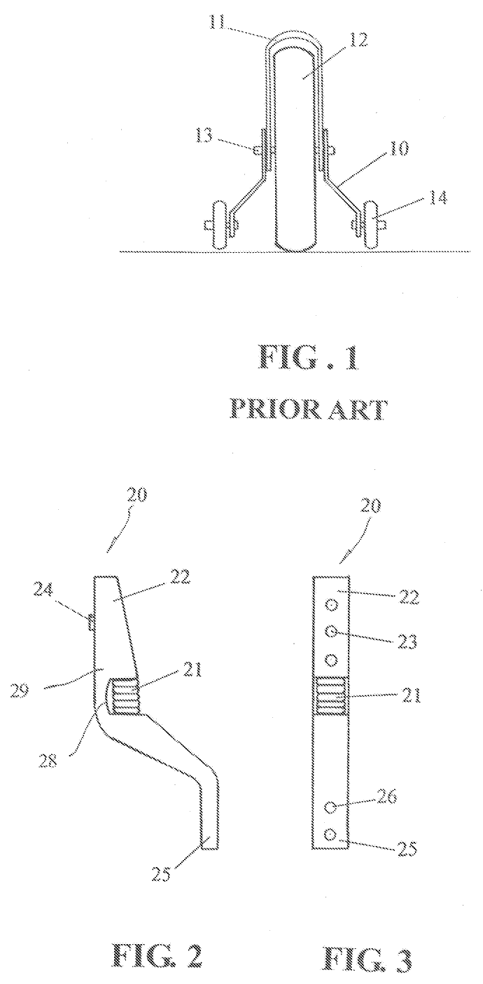

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to the drawings wherein FIG. 2 is a side view of an auxiliary wheel bracket according to the present invention and FIG. 3 is a front view of the auxiliary wheel bracket thereof, the auxiliary wheel bracket 20 comprises a resilient body portion 29. The intermediate portion of the resilient body portion 29 has a recess 28 in which is fitted a resilient member 21 such as a coil spring of the like. The upper end of the bracket 20 has a plurality of fixing holes 23 for engaging rear wheels with different diameters. The inner side of the upper end of the bracket 20 is provided with a protuberance 24 for engaging with the rear stay (not shown) of a bicycle. The lower end 25 of the bracket 20 is provided with a plurality of fixing holes 26 for engaging with auxiliary wheels with different diameters.

As shown in FIGS. 2 and 3, the auxiliary wheel bracket according to the present invention is characterized by a resilient means 21 such as a coil spring fitted in a recess of the bracket 20 for absorbing vibration from the upper and lower ends of the bracket 20 thereby making the rider feel more comfortable. Furthermore, the restoration of the body portion 29 and the resilient member 21 will make it easier for the rider to keep along the traveling direction even if the bicycle is slight tilted thus enhancing the rider's safety.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-2. (canceled)

3. In a bicycle having an auxiliary wheel bracket and a rear stay, the improvement wherein said auxiliary wheel bracket comprises a resilient body portion, an intermediate portion of said resilient body portion having a recess in which is fitted a coil spring, an upper end of said bracket having a plurality of fixing holes for engaging rear wheels of different diameters, an inner side of said upper end of said bracket being provided with a protuberance for engaging wit said rear stay, a lower end of said bracket being provided wit a plurality of fixing holes for engaging with auxiliary wheels wit different diameters, whereby said coil spring will absorb vibration from said upper and lower ends of said bracket thereby making a rider feel more comfortable and restoration of said body portion and said coil spring will make it easier for said rider to keep along traveling direction even if said bicycle is slight tilted thus enhancing said rider's safety.
